(19) United States
(12) Patent Application Publication
(10) Pub. No.: US 2026/0273880 A1
(43) Pub. Date: Sep. 17, 2026

(54) COEXTRUDED CONVEYOR GUIDE AND APPLICATION METHOD

(71) Applicant: Lion Extrusion, LLC, Kentwood, MI (US)

(72) Inventor: Franco Milco Marchetti, Ada, MI (US)

(73) Assignee: Lion Extrusion, LLC, Kentwood, MI (US)

(21) Appl. No.: 19/563,450

(22) Filed: Mar. 11, 2026

Related U.S. Application Data
(60) Provisional application No. 63/770,118, filed on Mar. 11, 2025.

(51) Int. Cl. B29D 29/06; B29C 65/10; B29C 65/78; B29L 31/00

(52) U.S. Cl. CPC B29D 29/06; B29C 65/10; B29C 65/7841; B29L 2031/7092

(57) ABSTRACT

A coextruded conveyor guide for a conveyor belt includes a guide portion coextruded with an interfacing portion. The guide portion has an elongated body and comprises a thermoplastic polymer. The interfacing portion is disposed over and extruded along the elongated body of the guide portion. The interfacing portion comprises a thermoplastic elastomer having a higher polarity than the thermoplastic polymer. The guide portion and the interfacing portion together have a transverse cross-section that has a trapezoidal shape defining a base surface, an engagement surface larger than and parallel with the base surface, and angled side surfaces connecting between the base surface and the engagement surface. In some examples, the angled side surfaces extend at generally the same angle between the base surface and the engagement surface. The engagement surface comprises the interfacing portion and the base surface comprises the guide portion.

### CROSS-REFERENCE TO RELATED APPLICATION

This application claims the benefit and priority under 35 U.S.C. §119(e) of U.S. provisional application Ser. No. 63/770,118, filed on Mar. 11, 2025, the content of which is incorporated herein by reference in its entirety.

### TECHNICAL FIELD

The present disclosure relates to flexible polymer guides that are attached to conveyor belts, and more specifically to guides formed of thermoplastic polymer that are attached to the underside of conveyor belts.

### BACKGROUND

Conveyor belts are commonly provided with guides along the underside that interface with grooves in the corresponding conveyor drums to generally prevent lateral movement of the belt relative to its path of rotation. To attach a guide to the underside of a fabric conveyor belt, a belt is typically pre-marked with a hand-drawn line along the underside surface at a desired location for the corresponding groove interface. The belt is then pre-treated with an etching and/or buffing process along the marked line before a quick-set adhesive is applied to the etched portion of the belt surface. The applied adhesive is then used to adhere a separate guide along the etched, underside surface of the belt. Each of these separate and often manual steps introduce opportunities for error, such as misalignment of the guide from the desired location, damage to the belt in unintended etching areas, and inconsistent application of adhesive, among other issues that can severely impact the operational efficiency, quality, and life of the conveyor belt. Accordingly, there remains a need for a conveyor guide that can be reliably and consistently bonded to the underside of a fabric conveyor belt without the use of adhesives or mechanical fasteners, that eliminates manual marking, etching, and adhesive application steps, and that is resistant to delamination under lateral shear forces encountered during conveyor operation.

### SUMMARY

The present disclosure provides a coextruded conveyor guide for a conveyor belt and a method of applying a coextruded conveyor guide to the underside of a conveyor belt. The conveyor belt includes a fabric carcass that continuously supports and defines the base and underside of the conveyor belt. The fabric carcass may be made up of a woven structure of filaments, with at least some of the filaments arranged longitudinally in a conveyance direction to withstand tensile stresses put on the conveyor belt. A polymer coating may be disposed over an upper side of the fabric carcass, such as a polyvinyl chloride resin or a thermoplastic resin, such as thermoplastic urethane. For example, a polymer may be disposed over an upper side of the fabric carcass, such as a polyvinyl chloride resin with a plasticizer additive to provide an added robustness to the belt at a relatively low cost.

According to an aspect of the disclosure, a coextruded conveyor guide for a conveyor belt includes a guide portion coextruded with an interfacing portion. The guide portion has an elongated body and comprises a thermoplastic polymer. The interfacing portion is disposed over and extruded along the elongated body of the guide portion. The interfacing portion includes a thermoplastic elastomer that has a higher polarity than the thermoplastic polymer. The guide portion and the interfacing portion together have a transverse cross section that has a trapezoidal shape defining a base surface, an engagement surface larger than and parallel with the base surface, and angled side surfaces connecting between the base surface and the engagement surface. In some examples, the angled side surfaces extend at generally the same angle between the base surface and the engagement surface. The engagement surface comprises the interfacing portion and the base surface comprises the guide portion.

In some implementations, the interfacing portion is configured to thermally bond to an underside of a fabric conveyor belt when the engagement surface is heated and pressed against the underside of the fabric conveyor belt. The guide portion, in some examples, is configured to engage in a groove of a rotating drum that movably supports a conveyor belt in a conveyance direction, where the groove is disposed around a circumference of the rotating drum. Also, in some examples, the guide portion may include notches formed into the base surface at spaced intervals along the length of the guide portion, such as to permit the guide portion to bend to a greater degree so as to engage around a drum with a smaller diameter.

In additional implementations, the thermoplastic elastomer of the interfacing portion is fused to the thermoplastic polymer of the guide portion via the coextrusion. In some examples, the guide portion has a height in the direction between the base and engagement surfaces, such that the height of the guide portion is greater than 2 mm along a length of the guide portion. Also, in some examples, the interfacing portion has a thickness in the direction between the base and engagement surfaces, such that the thickness of the interfacing portion is greater than 0.5 mm along a length of the interfacing portion. The thickness of the interfacing portion, in some implementations, is greater near the angled side surface than at a center of the engagement surface.

In additional implementations, the guide portion comprises polyvinyl chloride and may include a plasticizer additive that improves the flexibility and durability of the polyvinyl chloride. Also, the interfacing portion may comprise polyester. In some examples, a mass ratio of the guide portion to the interfacing portion is at least 10:1, and more preferably 100:1.

According to another aspect of the disclosure, a method provides a coextruded conveyor guide that has a guide portion comprising a thermoplastic polymer and an interfacing portion comprising a thermoplastic elastomer. The interfacing portion is extruded along the guide portion. A conveyor belt moves in the conveyance direction over a rotating drum having a groove around the circumference of the rotating drum. The interfacing portion of the coextruded conveyor guide is heated above 200° C, and preferably around 300° C. The heated interfacing portion is positioned against an underside of the conveyor belt in a location aligned with the groove of the rotating drum. The heated interfacing portion is pressed against an underside of the conveyor belt with the force that the rotating drum exerts against the conveyor belt.

In some implementations, heat is applied with hot air that is moved across the interfacing portion as it enters the groove of the rotating drum. The interfacing portion thermally bonds to the underside of a fabric conveyor belt when the engagement surface is heated and pressed against the underside of the conveyor belt. The pressing of the heated interfacing portion, in some examples, at least partially impregnates the interfacing portion into a fabric carcass of the fabric conveyor belt.

In additional examples, the guide portion and the interfacing portion together have a transverse cross section that has a trapezoidal shape defining a base surface, an engagement surface larger than and parallel with the base surface, and angled side surfaces connecting between the base surface and the engagement surface. The engagement surface may include the interfacing portion, and the base surface may include the guide portion.

In some implementations, the guide portion has a height in the direction between the base and engagement surfaces, where the height of the guide portion may be greater than 2 mm along a length of the guide portion. Also, in some examples, the interfacing portion has a thickness in the direction between the base and engagement surfaces, where the thickness of the interfacing portion may be greater than 0.5 mm along a length of the interfacing portion. The thickness of the interfacing portion may be greater near the angled side surface than at a center of the engagement surface. Also, in some implementations, a mass ratio of the guide portion to the interfacing portion is at least 10:1, and more preferably 100:1.

Implementations of the disclosure may include one or more of the preceding features in various combinations.

### BRIEF DESCRIPTION OF THE DRAWINGS

FIG. 1 is a top perspective view of a conveyor assembly having a conveyor belt with a coextruded conveyor guide.

FIG. 2 is a cross-sectional view of the conveyor belt and a drum of the conveyor assembly taken at line II-II shown in FIG. 1.

FIG. 3 is an upper perspective view of a portion of the conveyor belt and the coextruded conveyor guide.

FIG. 4 is a lower perspective view of the portion of the conveyor belt and the coextruded conveyor guide.

FIG. 5 is an upper perspective view of the coextruded conveyor guide.

FIG. 6 is an end view of the coextruded conveyor guide shown in FIG. 5.

FIG. 7 is a side schematic view of a conveyor assembly having a coextruded conveyor guide being heated and applied to an underside of a conveyor belt.

FIG. 8 is a cross-sectional view of the coextruded conveyor guide spaced from the conveyor belt, as shown at line VIII-VIII of FIG. 7.

FIG. 9 is a cross-sectional view of the coextruded conveyor guide applied to the conveyor belt, as shown at line IX-IX of FIG. 7.

FIG. 10 is a lower perspective view of the coextruded conveyor guide.

FIG. 11 is a lower perspective view of an additional example of a coextruded conveyor guide having notches.

FIG. 12 is a lower perspective view of an additional example of a coextruded conveyor guide having notches.

FIG. 13 is a cross-sectional view of the conveyor belt shown in FIG. 1.

FIGS. 14-16 are cross-sectional views of additional examples of a conveyor belt having two coextruded conveyor guides.

The details of one or more examples of the disclosure are set forth in the accompanying drawings and the description below. Other aspects, advantages, purposes, and features will be apparent upon review of the following specification in conjunction with the drawings, where like reference numerals indicate like parts.

### DETAILED DESCRIPTION

Referring now to the drawings and the illustrative embodiments depicted therein, a coextruded conveyor guide 112 is provided on the underside of a conveyor belt 100. The conveyor belt 100 includes a fabric carcass 102 (FIG. 2) that defines the supportive base and underside of the conveyor belt 100. The fabric carcass 102 may be formed of a woven structure of filaments 104, with at least some of the filaments arranged longitudinally in a conveyance direction to withstand tensile stresses put on the conveyor belt 100. A polymer coating 106 may be disposed in one or more layers over an upper side of the fabric carcass, such as with a polyvinyl chloride resin and/or a thermoplastic resin, such as polyester. In addition, it is contemplated that the coextruded conveyor guide 112 may be used on additional types of accommodating conveyor belts and conveyor systems than those shown.

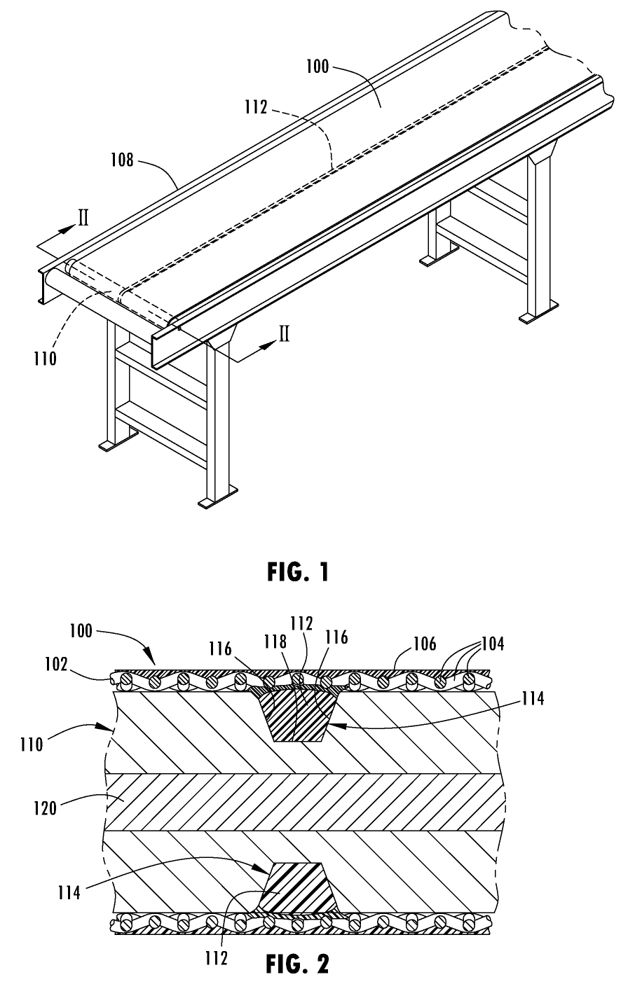

As shown in FIG. 1, the conveyor belt 100 is operated as part of a conveyor system, where the conveyor belt 100 is movably supported by a structure 108, such as an elevated structure for moving the conveyor belt at a desirable height above the floor surface. The structure 108 may support a drive motor that drives rotation of a drum that rotationally moves the conveyor belt 100 in a conveyance direction along the length of the conveyor belt 100. For example, the structure may arrange the conveyor belt to span between pulleys and/or drums in an unsupported manner or in a supported manner, such as with a smooth bed, a bearing surface bed, or a roller bed to support the suspended conveyor belt 100. The structure 108, as shown in FIG. 1, supports a drum 110, such as a head or tail drum, at the end or return point of the conveyor belt 100. The drum 110 is rotatable and functions to guide the conveyor belt around the end or return point to move in the opposite direction, while maintaining tension and alignment of the conveyor belt 100 on the drum 110.

The exemplary drum 110, as illustrated in FIG. 2, has a groove 114 that is engaged by a guide 112 that is attached to the bottom surface of the conveyor belt 100. The groove 114 is formed around the circumference of the rotating drum 110 in a shape that is configured to receive the guide 112. Specifically, the groove 114 shown in FIG. 2 has a trapezoidal shape with side surfaces 116 that extend radially into the drum 110 and terminate at a bottom surface 118 of the groove 114. With the guide 112 seated in the groove 114, the lateral position and alignment of the conveyor belt are consistently maintained and accurately tracked on the drum 110. The exemplary drum 110 has an axle 120 that functions to rotate the drum 110; however, in additional examples, the drum or pulley may rotate about end spindles or alternative rotational mechanisms.

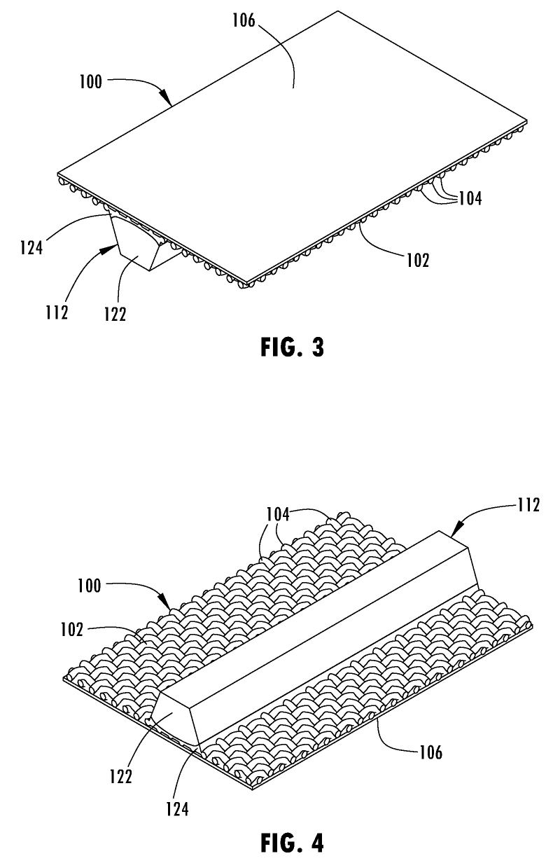

As further shown in FIGS. 3 and 4, the conveyor belt 100 has a fabric carcass 102 formed of a woven structure of filaments 104, with at least some of the filaments arranged longitudinally in a conveyance direction to withstand tensile stresses put on the conveyor belt 100. The fabric carcass can be any conventional weave, such as a weave with relatively wide openings to allow for impregnation with resin. It is also contemplated that the belt carcass may be a composite material with strands of monofilaments, such as carbon fibers, metals, or any conventional belt materials. Further, the belt carcass may also be a non-woven carcass, such as a polyester or aramid needle felt. A polymer coating 106, such as shown in FIGS. 3 and 4, may be disposed over an upper side of the fabric carcass 102 and partially flow into and impregnate the fibers and spaces between the filaments 104. The polymer coating may be applied in one or more layers, such as to provide different belt properties and capabilities. For example, a first polymer layer may be disposed over an upper side of the fabric carcass 102 and a second polymer layer disposed over the cured first polymer layer.

The polymer coating may be a thermoplastic resin, such as polyvinyl chloride (PVC) combined with a plasticizer additive to provide added robustness to the belt at a relatively low cost. The polymer coating may also or alternatively include a thermoplastic polyester elastomer, such as DuPont™ Hytrel®, which may define an outer surface of the conveyor belt to provide improved resiliency and durability. Where the polymer coating includes a thermoplastic polyester elastomer, the underside of the conveyor belt presents a polyester-bearing surface that is chemically compatible with the thermoplastic polyester elastomer of the interfacing portion 124, thereby promoting a strong thermal bond between the interfacing portion 124 and the underside of the conveyor belt 100 upon heating and pressing. It is further contemplated that the polymer coating may be one or more other thermoplastic polymers or thermosetting polymers, such as polyurethane or the like.

As further shown in FIGS. 3 and 4, the coextruded conveyor guide 112 is thermally bonded to the underside of the conveyor belt 100 so as to extend along the length of the belt 100 in alignment with the conveyance direction. The guide 112 includes a guide portion 122 coextruded with an interfacing portion 124. The interfacing portion 124 is disposed over and extruded along the elongated body of the guide portion 122. The guide portion 122 comprises a thermoplastic polymer, such as polyvinyl chloride (PVC) combined with a plasticizer additive. The interfacing portion 124 comprises a thermoplastic elastomer having a higher polarity and potentially a lower melting temperature than the thermoplastic polymer.

For example, the interfacing portion 124 may comprise a thermoplastic polyester elastomer, such as DuPont™ Hytrel®, which is configured to thermally bond directly with the fabric carcass 102 that at least partially defines the underside of the conveyor belt 100. Where the fabric carcass 102 is formed of polyester filaments 104, the thermoplastic polyester elastomer of the interfacing portion 124 is chemically compatible with the polyester filaments 104, such that upon heating to at least 200° C and pressing against the underside of the conveyor belt 100, the interfacing portion 124 at least partially melts and flows into the interstices of the fabric carcass 102, forming a thermal bond upon cooling that is reinforced by mechanical interlocking with the filaments 104 of the fabric carcass 102. Additionally, where the polymer coating 106 comprises a thermoplastic polyester elastomer at the underside of the conveyor belt 100, the interfacing portion 124 is further configured to thermally fuse with the polymer coating 106 by virtue of their chemical compatibility, thereby providing an additional bonding interface between the interfacing portion 124 and the conveyor belt 100. This dual bonding mechanism, thermal fusion with the polymer coating 106 and mechanical interlocking with and thermal bonding to the fabric carcass 102, provides a bond between the coextruded conveyor guide 112 and the conveyor belt 100 that exhibits strong resistance to delamination under the lateral shear forces encountered during conveyor operation.

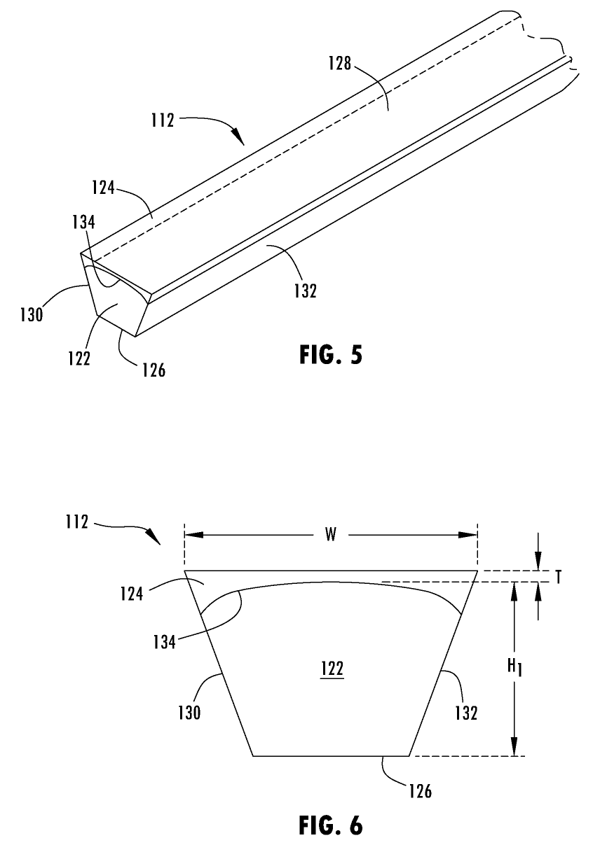

As shown in FIGS. 5 and 6, the guide portion 122 and the interfacing portion 124 together have a transverse cross section that has a trapezoidal shape defining a base surface 126, an engagement surface 128 larger than and parallel with the base surface 126, and angled side surfaces 130, 132 connecting between the base surface 126 and the engagement surface 128. In the illustrated example, the angled side surfaces 130, 132 extend at generally the same angle between the base surface 126 and the engagement surface 128. The engagement surface 128 comprises the interfacing portion 124, and the base surface 126 comprises the guide portion 122. Accordingly, the interfacing portion 124, providing the preferable material for thermal bonding, will cover at least the lateral edges of the engagement surface 128 and preferably the entire engagement surface 128. By covering at least the lateral edges of the engagement surface 128, the interfacing portion 124 provides a strong resistance to lateral shear forces that act on the guide 112 relative to the belt 100, such as during operation when the guide 112 operates to prevent lateral movement of the belt 100 as it rides in the groove 114 (FIG. 2).

As also shown in FIGS. 5 and 6, the thermoplastic elastomer of the interfacing portion 124 is fused to the thermoplastic polymer of the guide portion 122 via coextrusion, so as to form a fused interface 134 therebetween. The fused interface 134 that is formed via coextrusions is generally void of any gaps or inconsistencies. The guide portion 122 has a height H in the direction between the base and engagement surfaces 126, 128, such that the height H of the guide portion is greater than 2 mm or approximately 2.5 mm along a length of the guide 112, and preferably the height H is consistent along the length of the guide 112. Likewise, the interfacing portion 124 has a thickness T in the direction between the base and engagement surfaces 126, 128, such that the thickness T of the interfacing portion 124 is greater than 0.2 mm or greater than 0.4 mm or approximately 0.5 mm at the center of the engagement surface 128, and preferably the thickness T is consistent along the length of the guide 112. The thickness T of the interfacing portion 124, as shown in FIG. 6, may be greater at the lateral edges of the guide 112 near the angled side surfaces 130, 132, than at a center of the engagement surface 128. Overall, a mass ratio of the guide portion 122 to the interfacing portion 124 is at least 10:1, or more preferably 100:1, or 1000:1.

In additional examples, such as to correspond to standard guide sizes, the overall height of the guide 112 may be between 4 mm and 14 mm and the corresponding overall width W of the guide 112 may be between 6 mm and 22 mm. For example, for standard trapezoidal guides, the overall width x height dimensions (in millimeters) can be 6x4, 8x5, 10x6, 13x8, 17x11, or 22x14, among other generally known guide sizes.

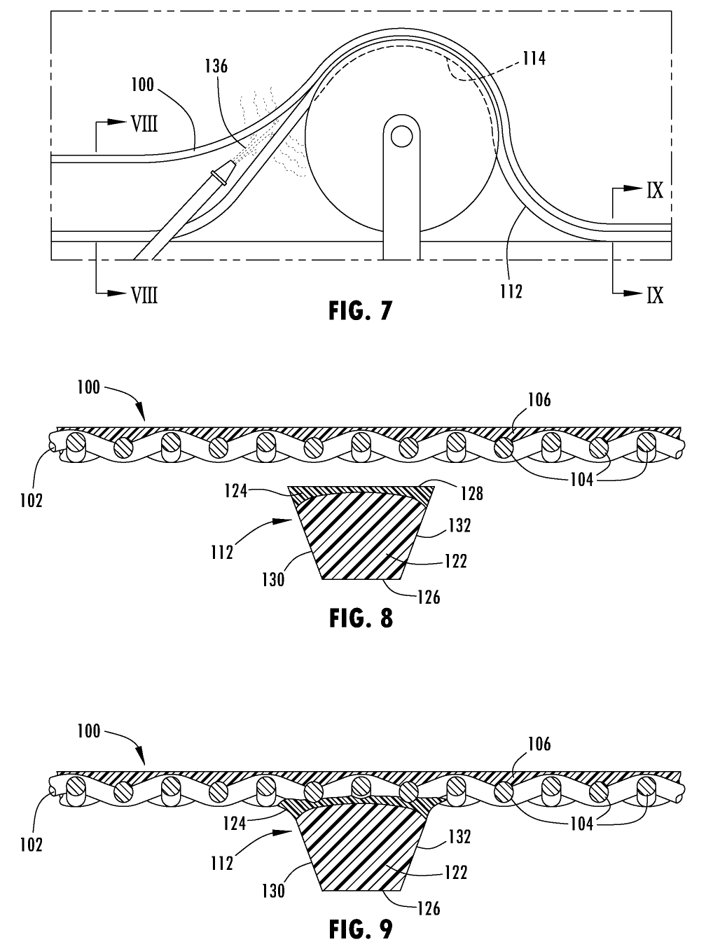

As shown in FIGS. 7-9, the interfacing portion 124 of the guide 112 is thermally bonded to an underside of a conveyor belt 100 when the engagement surface 128 (FIG. 8) is heated and pressed against the underside of the fabric conveyor belt 100. The interfacing portion 124 of the coextruded conveyor guide 112 is heated to its melting point, such as above 200° C, and preferably around 300° C. As shown in FIG. 7, the heat is applied with hot air 136 that is moved across the interfacing portion 124 as it enters the groove 114 of a rotating drum. The heated interfacing portion 124 is positioned against an underside of the conveyor belt 100 in a location aligned with the groove 114 of the rotating drum. The heated interfacing portion 124 is pressed against an underside of the conveyor belt 100 with the force generated at the drum-belt interface as a result of conveyor belt 100 tension during operation.

The interfacing portion 124 thermally bonds to the underside of the conveyor belt 100 when the engagement surface 128 is heated to at least 200° C and pressed against the underside of the conveyor belt 100. The thermal bond is facilitated by the chemical compatibility between the thermoplastic polyester elastomer of the interfacing portion 124 and the polyester-bearing materials of the conveyor belt 100, including the polyester filaments 104 of the fabric carcass 102 and, where present, any thermoplastic polyester elastomer component of the polymer coating 106 at the underside of the conveyor belt 100. As shown in FIG. 9, the pressing of the heated interfacing portion 124 causes the interfacing portion 124 to at least partially melt and flow into the interstices defined by the woven filaments 104 of the fabric carcass 102 and into any uneven surfaces on the underside of the conveyor belt 100. Upon cooling, the interfacing portion 124 solidifies within the fabric carcass 102, forming a bond that combines thermal fusion at the material interfaces with mechanical interlocking within the fabric carcass 102. This combination of thermal fusion and mechanical interlocking produces a bond that resists delamination of the coextruded conveyor guide 112 from the conveyor belt 100 under the lateral shear forces applied to the guide 112 during conveyor operation, without the use of adhesives or mechanical fasteners.

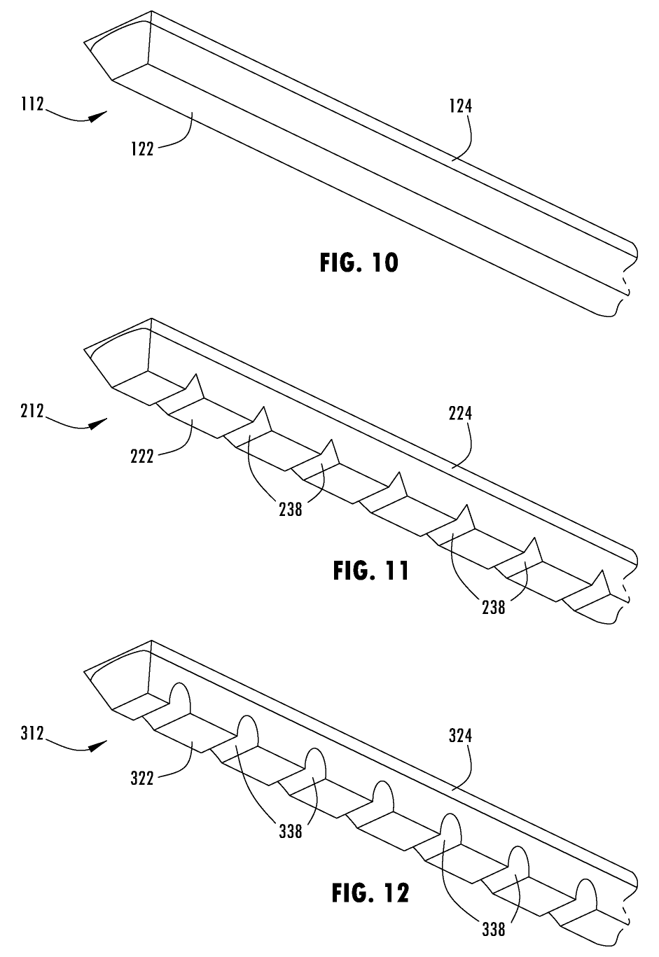

As shown in FIG. 10, the guide portion 122 and the interfacing portion 124 of the guide 112 are substantially uniform along the length of the guide 112. Specifically, the guide portion 122 shown in FIG. 10 may be generally void of any notches. In some examples, such as shown in FIGS. 11 and 12, the guide portion may include notches 238, 338 formed into the base surface at spaced intervals along the length of the guide portion, such as to permit the guide portion to bend to a greater degree so as to engage around a drum with a smaller diameter. As shown in FIG. 11, the notches 238 are generally V-shaped. Also, as shown in FIG. 12, the notches are generally U-shaped.

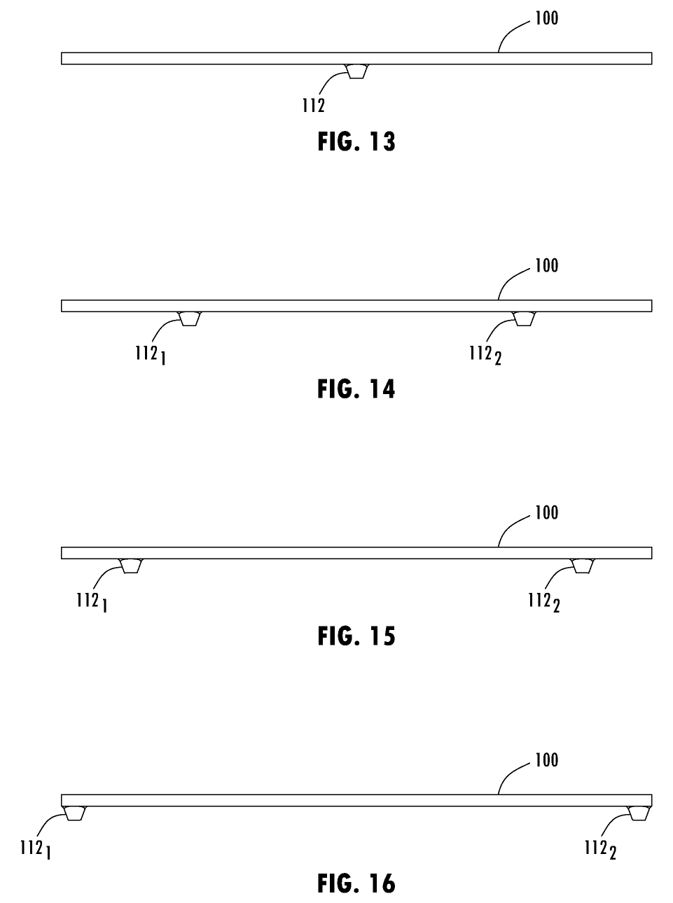

As shown in FIG. 13, the guide 112 is positioned laterally at approximately the center of the conveyor belt 100. Also, as shown in FIGS. 14-16, more than one guide may be bonded to the underside of the conveyor belt to accommodate different conveyor systems. For example, as shown in FIG. 14, the guides 112₁, 112₂are located at generally equal spacing between the center of the conveyor belt and the lateral edges thereof. Also, as shown in FIG. 15, the guides 112₁, 112₂are located laterally outward from those shown in FIG. 14. And as further shown in FIG. 16, the guides 112₁, 112₂are located laterally outward from those shown in FIGS. 14 and 15 at the lateral edges of the conveyor belt 100.

For purposes of this disclosure, the articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote one element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Further, it should be understood that any directions or reference frames in the preceding description are merely relative directions or movements. For example, the terms “upper,” “lower,” “right,” “left,” “rear,” “front,” “vertical,” “horizontal,” “inboard,” “outboard” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A coextruded conveyor guide for a conveyor belt, the coextruded conveyor guide comprising:
a guide portion having an elongated body and comprising a thermoplastic polymer; and
an interfacing portion disposed over and extruded along the elongated body,
wherein the interfacing portion comprises a thermoplastic elastomer having a higher polarity than the thermoplastic polymer,
wherein the guide portion and the interfacing portion together have a transverse cross section that has a trapezoidal shape defining a base surface, an engagement surface larger than and parallel with the base surface, and angled side surfaces connecting between the base surface and the engagement surface,
wherein the engagement surface comprises the interfacing portion, and
wherein the base surface comprises the guide portion.

2. The coextruded conveyor guide of claim 1, wherein the thermoplastic elastomer of the interfacing portion is fused to the thermoplastic polymer of the guide portion via coextrusion.

3. The coextruded conveyor guide of claim 1, wherein the interfacing portion is configured to thermally bond directly to an underside of a fabric conveyor belt without adhesive when the engagement surface is heated and pressed against the underside of the fabric conveyor belt.

4. The coextruded conveyor guide of claim 1, wherein the guide portion comprises a height in a direction between the base and engagement surfaces, and wherein the height of the guide portion is greater than 2 mm along a length of the guide portion.

5. The coextruded conveyor guide of claim 1, wherein the interfacing portion comprises a thickness in a direction between the base and engagement surfaces, and wherein the thickness of the interfacing portion is greater than 0.2 mm along a length of the interfacing portion.

6. The coextruded conveyor guide of claim 5, wherein the thickness of the interfacing portion is greater near the angled side surface than at a center of the engagement surface.

7. The coextruded conveyor guide of claim 1, wherein the angled side surfaces extend at generally the same angle between the base surface and the engagement surface.

8. The coextruded conveyor guide of claim 1, wherein the guide portion comprises polyvinyl chloride, and wherein the interfacing portion comprises polyester.

9. The coextruded conveyor guide of claim 1, wherein a mass ratio of the guide portion to the interfacing portion is at least 10:1.

10. A method comprising:
providing a coextruded conveyor guide that has a guide portion comprising a thermoplastic polymer and an interfacing portion extruded along the guide portion and comprising a thermoplastic elastomer;
moving a conveyor belt in a conveyance direction over a rotating drum having a groove around a circumference of the rotating drum;
heating the interfacing portion of the coextruded conveyor guide above 200° C;
positioning the heated interfacing portion against an underside of the conveyor belt in a location aligned with the groove of the rotating drum; and
pressing the heated interfacing portion against an underside of the conveyor belt with a force that the rotating drum is exerting against the conveyor belt.

11. The method of claim 10, wherein the heat is applied with hot air moved across the interfacing portion as it enters the groove of the rotating drum.

12. The method of claim 10, wherein the guide portion and the interfacing portion together have a transverse cross section that has a trapezoidal shape defining a base surface, an engagement surface larger than and parallel with the base surface, and angled side surfaces connecting between the base surface and the engagement surface, and wherein the engagement surface comprises the interfacing portion.

13. The method of claim 12, wherein the guide portion comprises a height in the direction between the base surface and the engagement surface, and wherein the height of the guide portion is greater than 2 mm along a length of the guide portion.

14. The method of claim 12, wherein the interfacing portion comprises a thickness in the direction between the base surface and the engagement surface, and wherein the thickness of the interfacing portion is greater than 0.5 mm along a length of the interfacing portion.

15. The method of claim 10, wherein the interfacing portion thermally bonds to the underside of a fabric conveyor belt when an engagement surface of the interfacing portion is heated and pressed against the underside of the conveyor belt.

16. The method of claim 15, wherein the pressing of the heated interfacing portion at least partially impregnates the interfacing portion into a fabric carcass of the conveyor belt.

17. A conveyor belt assembly comprising:
a conveyor belt having a fabric carcass; and
a coextruded conveyor guide thermally bonded to an underside of the fabric carcass, the coextruded conveyor guide comprising:
a guide portion having an elongated body; and
an interfacing portion disposed along the elongated body and bonded to the underside of the fabric carcass,
wherein the guide portion comprises a thermoplastic polymer,
wherein the interfacing portion comprises a thermoplastic elastomer having a higher polarity than the thermoplastic polymer, and
wherein the guide portion and the interfacing portion together have a transverse cross section that has a trapezoidal shape defining a base surface and an engagement surface larger than and parallel with the base surface.

18. The conveyor belt assembly of claim 17, wherein the engagement surface comprises the interfacing portion, wherein the base surface comprises the guide portion, and wherein the thermoplastic elastomer of the interfacing portion is fused to the thermoplastic polymer of the guide portion via coextrusion.

19. The conveyor belt assembly of claim 18, wherein the interfacing portion is at least partially impregnated into the fabric carcass of the conveyor belt.

20. The conveyor belt assembly of claim 18, wherein the guide portion comprises polyvinyl chloride, and wherein the interfacing portion comprises polyester.
